(19) United States
(12) Patent Application Publication
(10) Pub. No.: US 2021/0197752 A1
(43) Pub. Date: Jul. 1, 2021

(54) VEHICLE AIRBAGS FOR INHIBITING SHIFTING UPON IMPACT WHEN IN A DEPLOYED STATE

(71) Applicant: Toyota Motor Engineering & Manufacturing North America, Inc., Plano, TX (US)

(72) Inventors: Colby S. Williams, Milan, MI (US); Robert D. Smith, Dexter, MI (US); Jessica A. Riffe, Ann Arbor, MI (US)

(73) Assignee: Toyota Motor Engineering & Manufacturing North America, Inc., Plano, TX (US)

(21) Appl. No.: 16/731,520

(22) Filed: Dec. 31, 2019

(51) Int. Cl. B60R 21/2334; B60R 21/205; B60R 21/264; B60R 21/233

(52) U.S. Cl. CPC B60R 21/2334; B60R 21/205; B60R 2021/23308; B60R 21/233; B60R 21/264

(57) ABSTRACT

An airbag for a vehicle including a main bag body and a tail bag body is provided. The tail bag body extends forward from the main bag body in a vehicle longitudinal direction. The airbag is operable between an undeployed state and a deployed state such that, when the airbag is in the deployed state, the tail bag body extends into a cavity of an instrument panel defined by an upper wall, a front wall, and a lower wall. When in the deployed state, the tail bag body contacts at least one of the upper wall, the front wall, and a lower wall in order to inhibit movement of the main bag body in a vehicle vertical direction.

### TECHNICAL FIELD

The present specification generally relates to vehicle airbags and, more specifically, front passenger vehicle airbags for preventing shifting of the airbag upon impact of an occupant.

### BACKGROUND

Upon a vehicle collision, an airbag inflates in order to restrain an occupant within the vehicle and prevent the occupant from contacting the vehicle due to the sudden reduction in momentum of the vehicle. Thus, vehicles are equipped with a number of airbags situated around the vehicle to protect vehicle occupants from collision from any side of the vehicle. As such, a vehicle may be provided with front airbags for each of the driver and the occupant, knee airbags, roof rail airbags, and rear side airbags. In addition, different airbag configurations may be provided such as inflatable seat belts and pedestrian airbags.

When a vehicle's crash sensor recognizes a collision, information including the location of the collision is sent to the electronic control unit to determine which airbags are to be deployed to properly protect the occupants in the vehicle. However, upon impact of the occupant on the inflated airbag, the airbag may tend to shift based on the momentum of the occupant contacting the airbag. For instance, when a front passenger of a vehicle contacts the front passenger airbag inflating out of the instrument panel, the airbag may shift in a vehicle vertical direction. As a result, this may cause the airbag to shift out of position.

Accordingly, a need exists for alternative vehicle airbags for inhibiting shifting of the airbag upon impact of an occupant.

### SUMMARY

In one embodiment, airbags for a vehicle including an instrument panel having a cavity defined by an upper wall, a front wall, and a lower wall are provided. The airbag includes a main bag body and a tail bag body extending forward from the main bag body in a vehicle longitudinal direction when the airbag is in the deployed state. The tail bag body extends into the cavity of the instrument panel when the airbag is in a deployed state.

In another embodiment, vehicle instrument panel assemblies for restraining a front passenger during a vehicle impact include an instrument panel including an upper wall, a front wall, and a lower wall defining a cavity. The instrument panel includes an airbag housing and an airbag operable between an undeployed state and a deployed state in which the airbag is housed within the airbag housing when in the undeployed state. The airbag includes a main bag body and a tail bag body extending forward from the main bag body in a vehicle longitudinal direction when the airbag is in the deployed state. The tail bag body extends into the cavity of the instrument panel when the airbag is in the deployed state.

In yet another embodiment, vehicles for restraining a front passenger during a vehicle impact include a passenger compartment and a vehicle instrument panel assembly provided in the passenger compartment. The vehicle instrument panel assembly includes an instrument panel including an upper wall, a front wall, and a lower wall defining a cavity. The instrument panel also includes an airbag housing and an airbag operable between an undeployed state and a deployed state in which the airbag is housed within the airbag housing when in the undeployed state. The airbag includes a main bag body and a tail bag body extending forward from the main bag body in a vehicle longitudinal direction when the airbag is in the deployed state. The tail bag body extends into the cavity of the instrument panel when the airbag is in the deployed state.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a partial perspective view of an instrument panel of a vehicle in front of a passenger compartment of the vehicle having an airbag in an undeployed state according to one or more embodiments shown and described herein;

FIG. 2 schematically depicts a partial cross-sectional side view of the instrument panel of FIG. 1 having the airbag in a partially deployed state according to one or more embodiments shown and described herein;

FIG. 3 schematically depicts a partial cross-sectional side view the instrument panel of FIG. 1 having the airbag in a fully deployed state having a tail bag body extending into a cavity formed in the instrument panel according to one or more embodiments shown and described herein;

FIG. 4 schematically depicts a front perspective of the airbag of FIG. 2 in the fully deployed state and detached from the instrument panel according to one or more embodiments shown and described herein;

FIG. 5 schematically depicts an exploded view of individual pieces of material used to form the airbag of FIG. 2 according to one or more embodiments shown and described herein; and

FIG. 6 schematically depicts a partial rear view of the airbag of FIG. 2 in the fully deployed state and extending from the instrument panel according to one or more embodiments shown and described herein.

### DETAILED DESCRIPTION

Reference will now be made in detail to embodiments of the airbag described herein, examples of which are illustrated in the accompanying drawings. Whenever possible, the same reference numerals will be used throughout the drawings to refer to the same or like parts.

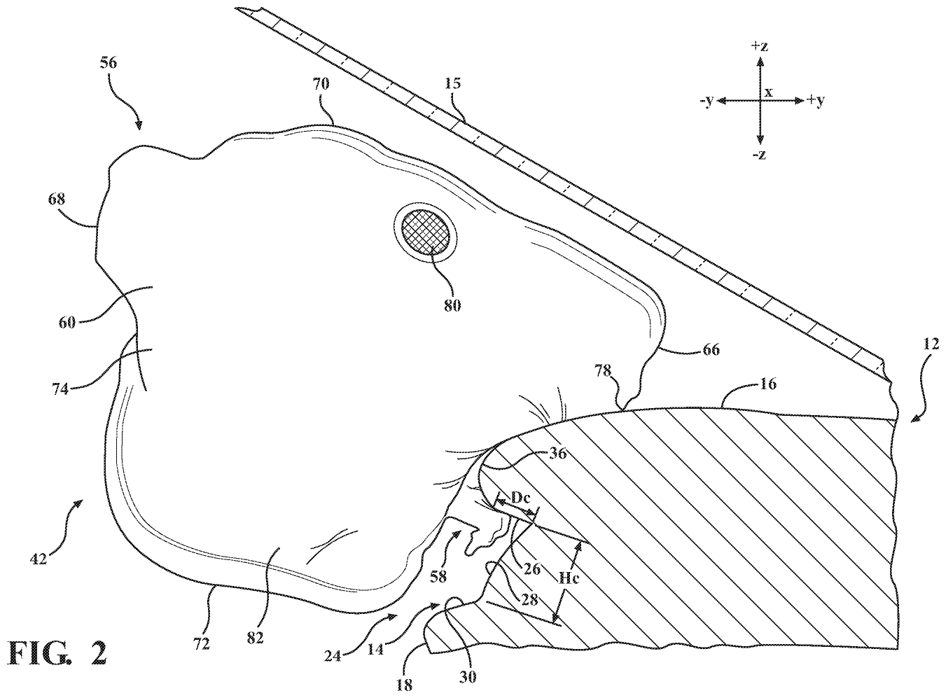

In some embodiments, an airbag for restraining a front passenger during a vehicle impact is depicted in FIG. 2 and generally includes a main bag body and a tail bag body extending forward from the main bag body in a vehicle longitudinal direction. The airbag is operable between an undeployed state and a deployed state in which the airbag is housed within an airbag housing provided in an instrument panel of the vehicle when in the undeployed state. The instrument panel assembly includes an instrument panel including an upper wall, a front wall, and a lower wall defining a cavity. The tail bag body of the airbag extends into the cavity of the instrument panel when the airbag is in the deployed state to inhibit movement of the airbag in a vehicle vertical direction. The cavity may be suitable for storing personal items, such as a cell phone, sunglasses, or the like. Various embodiments of the airbags and the operation of the airbags are described in more detail herein.

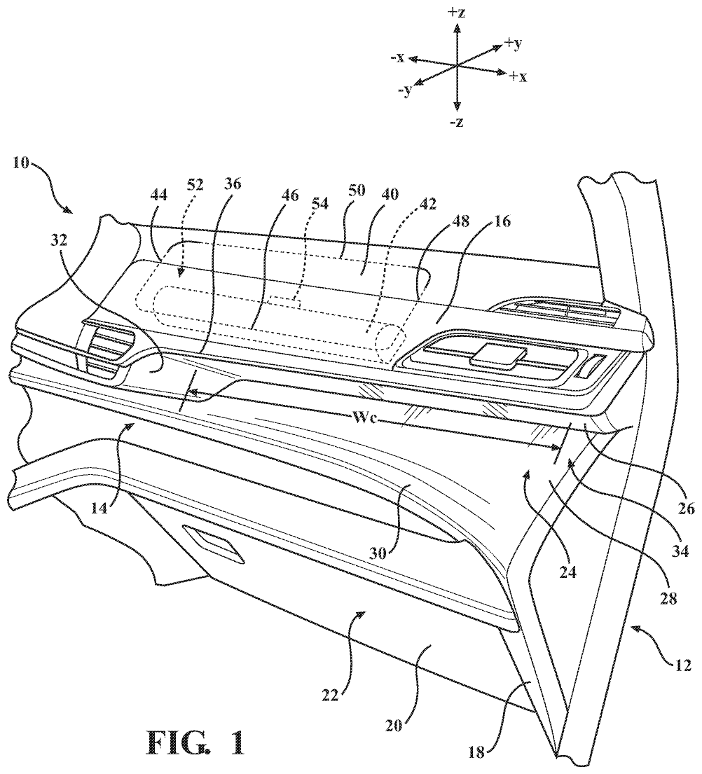

As used herein, the term “vehicle longitudinal direction” refers to the forward-rearward direction of the vehicle (i.e., in the +/− vehicle Y direction depicted in FIG. 1). The term “vehicle lateral direction” refers to the cross-vehicle direction (i.e., in the +/− vehicle X direction depicted in FIG. 1), and is transverse to the vehicle longitudinal direction. The term “vehicle vertical direction” refers to the upward-downward direction of the vehicle (i.e., in the +/− vehicle Z direction depicted in FIG. 1). As used herein, “upper” and “above” are defined as the positive Z direction of the coordinate axis shown in the drawings. “Lower” and “below” are defined as the negative Z direction of the coordinate axis shown in the drawings. Further, the terms “outboard” or “outward” as used herein refers to the relative location of a component with respect to a vehicle centerline. The term “inboard” or “inward” as used herein refers to the relative location of a component with respect to the vehicle centerline. Because the vehicle structures may be generally symmetrical about the vehicle centerline, the direction to which use of terms “inboard,” “inward,” “outboard” and “outward” refer may be mirrored about the vehicle centerline when evaluating components positioned along opposite sides of the vehicle.

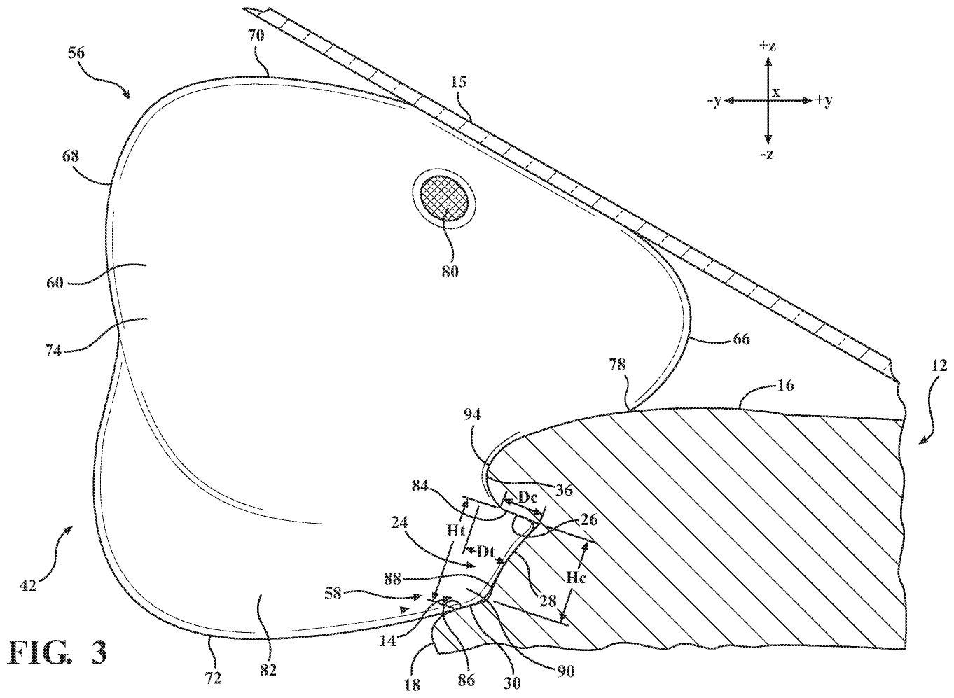

Referring now to FIG. 1, a vehicle 10 generally includes a passenger compartment 12 provided in an interior thereof. The passenger compartment 12 is a portion of an interior of the vehicle 10 which passengers or other occupants occupy. A plurality of vehicle seats (not shown) including a driver seat, front passenger seat, and one or more rear passenger seats may be provided within the passenger compartment 12 of the vehicle 10. An instrument panel 14 extends across the vehicle 10 in a vehicle lateral direction in front of the driver seat and the front passenger seat. The vehicle 10 also includes a windshield 15, shown in FIGS. 2 and 3.

The instrument panel 14 includes an upper surface 16 and a rear wall 18 facing the passenger compartment 12 of the vehicle 10. The instrument panel 14 may include a door 20 hingedly attached to the rear wall 18 in front of the front passenger seat in order to provide access to a storage compartment 22, such as a glove compartment. Above the storage compartment 22, the instrument panel 14 includes a cavity 24 formed therein defined by an upper wall 26, a front wall 28, and a lower wall 30.

Referring to FIGS. 2 and 3, the cavity 24 has a cavity height Hc defined by a distance between the upper wall 26 and the lower wall 30. The height Hc of the cavity 24 may be uniform throughout the cavity 24 or the height Hc might taper as it extends forward in the vehicle longitudinal direction into the instrument panel 14, which defines a cavity depth Dc of the cavity 24, or to a side of the instrument panel 14 in the vehicle lateral direction. The depth Dc of the cavity 24 may also be uniform throughout the height Hc of the cavity 24 or it may vary if the front wall 28 is curved, as shown. This results in the cavity 24 having a depth Dc slightly greater proximate the upper wall 26 and the lower wall 30 of the cavity 24.

In some embodiments, the cavity 24 is also defined by at least one side wall. As shown, a side wall 32 extends between the upper wall 26 and the lower wall 30. As shown in FIG. 1, the cavity 24 may have a cavity width Wc spanning between the side wall 32 and an open end 34 of the instrument panel 14, which is closed by a passenger vehicle door when shut. Alternatively, the cavity width Wc may extend between the side wall 32 of the cavity 24 and an opposite side wall, if provided.

Referring to FIGS. 1-3, the instrument panel 14 may include a lip 36. The lip 36 extends in the vehicle lateral direction. The lip 36 is positioned between the upper surface 16 of the instrument panel 14 and the upper wall 26 of the cavity 24. As such, the lip 36 defines the transition between the upper wall 26 of the cavity 24 and the upper surface 16 of the instrument panel 14.

Referring to FIG. 1, a rupturable door 40 is provided on the upper surface 16 of the instrument panel 14 for permitting the release of an airbag 42 when the vehicle 10 identifies a collision. In some embodiments, the rupturable door 40 includes three rupturable edges 44, 46, 48 that are separable from the instrument panel 14 and one nonrupturable edge 50. Thus, the rupturable door 40 is capable of rupturing and pivoting about the nonrupturable edge 50. An airbag housing 52 is provided within the instrument panel 14 beneath the rupturable door 40 and houses the airbag 42 in an undeployed state. An inflator 54 is provided in the airbag housing 52 and in fluid communication with the airbag 42.

The airbag 42 is formed from a thin, nylon fabric and folded within the airbag housing 52 in the undeployed state. In some embodiments, the inflator 54 is electrically connected to a collision sensor (not shown), which identifies when a collision has occurred based on a specific threshold being exceeded. The collision sensor then actuates the inflator 54. In some embodiments, the collision sensor is electrically connected to an electronic control unit (ECU) (not shown) of the vehicle 10 or a separate airbag electronic control unit (airbag ECU) acting as an intermediary between the collision sensor and the airbag 42. In this instance, the collision sensor sends data to the ECU or the airbag ECU which makes a determination as to whether the inflator 54 should be actuated.

When the collision sensor, the ECU, or the airbag ECU determines the airbag 42 should inflate, the inflator 54 provides a gaseous reaction resulting in the production of nitrogen. Such reactions include sodium azide (NaN₃) reacting with potassium nitrate (KNO₃) to produce nitrogen gas. The hot blasts from the nitrogen gas inflate the airbag 42 and the airbag 42 expands toward its deployed state. In doing so, the force of the airbag 42 expanding pushes against the rupturable door 40 until it separates from the instrument panel 14, which allows the airbag 42 to fully expand outside of the instrument panel 14 and in front of the front passenger seat of the vehicle 10.

As illustrated in FIG. 2, a side view of the instrument panel 14 and the airbag 42 in a partially deployed state is shown. As the airbag 42 inflates, the airbag 42 expands toward the front passenger seat. The airbag 42 includes a main bag body 56 and a tail bag body 58 extending forward from the main bag body 56 in the vehicle longitudinal direction.

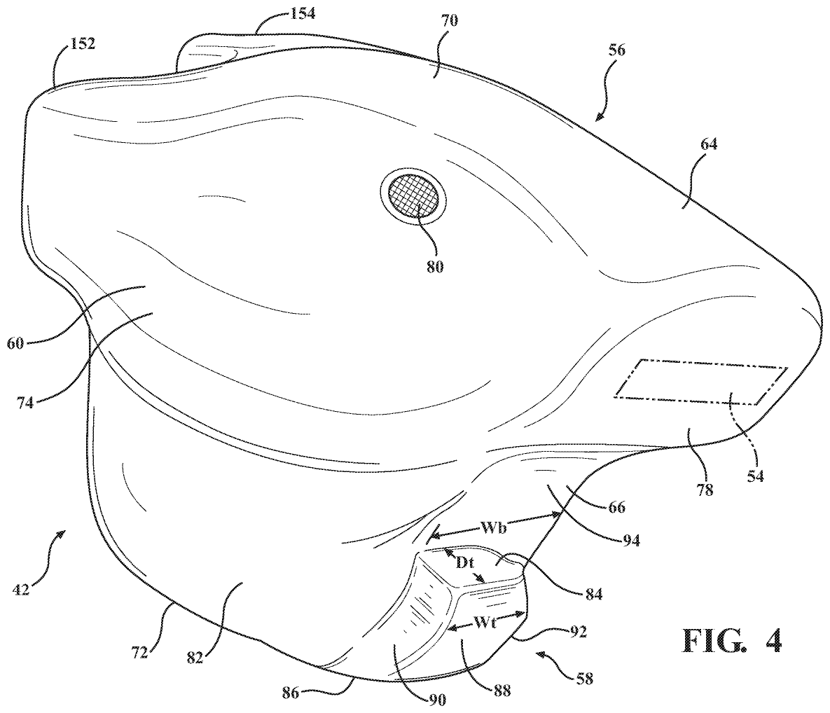

Referring to FIGS. 2-6, the main bag body 56 includes a pair of side panels 60, 62, defining a pair of side surfaces thereof, and a perimeter panel 64 sewn to the side panels 60, 62 at opposite edges thereof to provide the main bag body 56 with a main body width Wb equal to a perimeter width Wp of the perimeter panel 64. The perimeter panel 64 provides the airbag 42 with a front section 66, a rear section 68, a top section 70, and a bottom section 72. As noted above, the side panels 60, 62 are interconnected by the perimeter panel 64 and, thus, provide the airbag 42 with opposite side sections 74, 76. The front section 66 of the airbag 42 remains attached to the instrument panel 14 at a nose section 78 as it inflates. This maintains the general position of the airbag 42 in front of the front passenger seat as it inflates.

In some embodiments, the main bag body 56 includes at least one vent hole 80 for discharging gas that is supplied to the airbag 42. The vent hole 80 prevents the internal pressure within the airbag 42 from becoming excessive. The location of the vent hole 80 is determined in order to direct gas away from the occupant. As shown, the vent hole 80 is provided in one of the side panels 60, 62 of the airbag 42. However, a vent hole 80 may be provided in any other suitable location of the airbag 42, such as in the top section 70 or the bottom section 72, to direct the gas away from the occupant.

Referring to FIG. 2, in the partially deployed state, the main bag body 56 inflates in front of the front passenger seat and rearward of the instrument panel 14 abutting against the lip 36. The main bag body 56 includes a lower section 82 which covers a rear opening opposite the front wall 28 of the cavity 24 formed in the instrument panel 14. The tail bag body 58 is attached to the main bag body 56 at the lower section 82 thereof and extends forward toward the instrument panel 14. As such, the tail bag body 58 is positioned within the cavity 24.

Referring now to FIG. 3, when the airbag 42 is in the deployed state, top section 70 of the main bag body 56 inflates to contact the windshield 15. In addition, the tail bag body 58 inflates and, thus, expands within the cavity 24 in the instrument panel 14 after the main bag body 56 has inflated and gas flows from the main bag body 56 into the tail bag body 58. As will be discussed in more detail herein, the tail bag body 58 extends into the cavity 24 of the instrument panel 14 in order to prevent movement of the airbag 42 in the vehicle vertical direction when deployed. The tail bag body 58, when deployed, has an upper surface 84, a lower surface 86, a front surface 88 interconnecting the upper surface 84 and the lower surface 86, and a pair of opposite side surfaces 90, 92. As will be discussed in more detail herein, it is to be understood that the perimeter panel 64 forms the upper surface 84, the lower surface 86, and the front surface 88 of the tail bag body 58, while the side panels 60, 62 form the opposite side surfaces 90, 92 of the tail bag body 58. As a result, the tail bag body 58 has a tail width Wt defined by the width Wp of the perimeter panel 64 and, thus, equal to the width Wb of the main bag body 56.

The tail bag body 58 has a tail height Ht defined by the distance between the upper surface 84 and the lower surface 86 of the tail bag body 58. As will be discussed in more detail herein, it should be appreciated that the height Ht of the tail bag body 58 is determined based on the curvature of the side panels 60, 62. The height Ht of the tail bag body 58 is such that, when in the deployed state, at least one of the upper surface 84 and the lower surface 86 of the tail bag body 58 contacts at least one of the upper wall 26 and the lower wall 30 of the cavity 24.

The tail bag body 58 also has a tail depth Dt defined by the amount of forward extension of the tail bag body 58 from the main bag body 56. As such, the depth Dt of the tail bag body 58 is such that, when in the deployed state, the front surface 88 of the tail bag body 58 contacts the front wall 28 of the cavity 24. In some embodiments, when the airbag 42 is in the deployed state, at least one of the upper surface 84 and the lower surface 86 of the tail bag body 58 contacts the respective upper wall 26 and the lower wall 30 of the cavity 24. In other embodiments, the tail bag body 58 contacts each of the upper wall 26, the lower wall 30, and the front wall 28 of the cavity 24 when in the deployed state. A rearward indentation 94 is formed in the airbag 42 between the main bag body 56 and the upper surface 84 of the tail bag body 58 for receiving the lip 36 of the instrument panel 14.

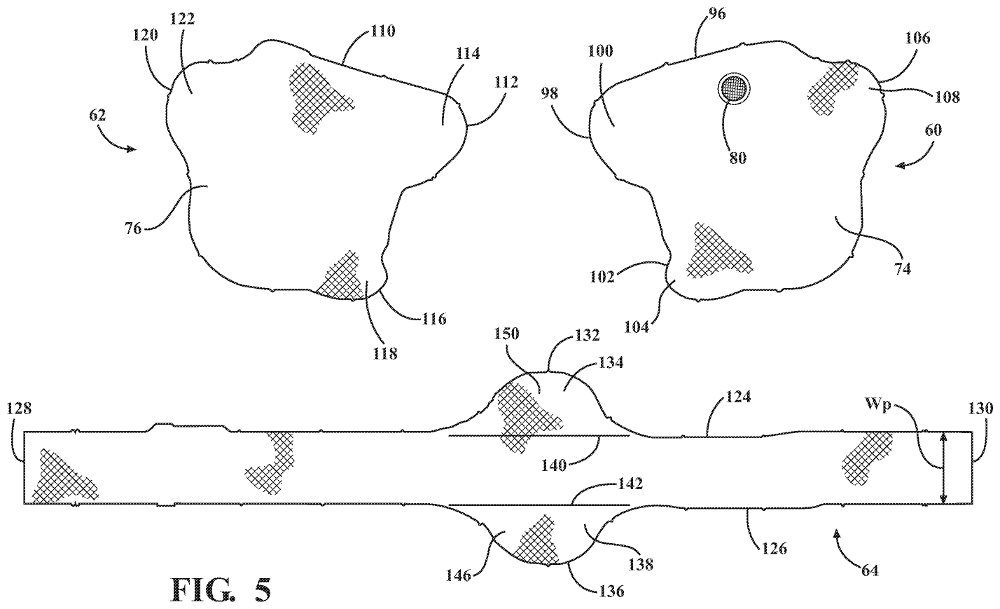

Referring now to FIG. 5, an exploded view of the airbag 42, including the side panels 60, 62 and the perimeter panel 64 forming the airbag 42, is shown. The first side panel 60, which includes the vent hole 80 formed therein, is defined by a first side panel edge 96. In some embodiments, the first side panel edge 96 has a first nose edge 98 defining a first nose bulge 100, a first tail edge 102 defining a first tail bulge 104, and a first lobe edge 106 defining a first lobe bulge 108. Similarly, the second side panel 62, which in some embodiments is identical to the first side panel 60, is defined by a second side panel edge 110. As such, the second side panel edge 110 has a second nose edge 112 defining a second nose bulge 114, a second tail edge 116 defining a second tail bulge 118, and a second lobe edge 120 defining a second lobe bulge 122.

The perimeter panel 64 is shown having a first perimeter edge 124, a second perimeter edge 126, a first end 128, and a second end 130. It is to be understood that the width Wp of the perimeter panel 64 shown is intended for illustrative purposes only and not meant to limit the scope of the present disclosure. As such, the width Wp of the perimeter panel 64 may be increased to increase the width Wm of the main bag body 56 and the width Wt of the tail bag body 58 to extend across a greater portion of the instrument panel 14 or, alternatively, the width Wp of the perimeter panel 64 may be reduced to decrease the width Wm of the main bag body 56 and the width Wt of the tail bag body 58.

In embodiments in which the first and second side panels 60, 62 include first and second lobe bulges 108, 122, the perimeter panel 64 also includes a third lobe edge 132 defining a third lobe bulge 134 extending from the first perimeter edge 124. Similarly, the perimeter panel 64 includes a fourth lobe edge 136 defining a fourth lobe bulge 138 extending from the second perimeter edge 126. The perimeter panel 64 also includes a first interior sew line 140 and a second interior sew line 142 proximate the third lobe bulge 134 and the fourth lobe bulge 138, respectively. The first interior sew line 140 is sewn in the perimeter panel 64 proximate the third lobe bulge 134 to provide the airbag 42 with an increased tensile strength proximate the third lobe bulge 134 and prevent inflation at that location. Similarly, the second interior sew line 142 is sewn in the perimeter panel 64 proximate the fourth lobe bulge 138 to provide the airbag 42 with an increased tensile strength and prevent inflation at that location.

It is to be understood that the length of the first perimeter edge 124 and the second perimeter edge 126 are equal to the length of the first side panel edge 96 and the second side panel edge 110. Thus, in assembling the airbag 42, the first end 128 and the second end 130 of the perimeter panel 64 are brought together and sewn to one another. As a result, the perimeter panel 64 is folded and positioned such that the first perimeter edge 124 mates with the first side panel edge 96 and the second perimeter edge 126 mates with the second side panel edge 110.

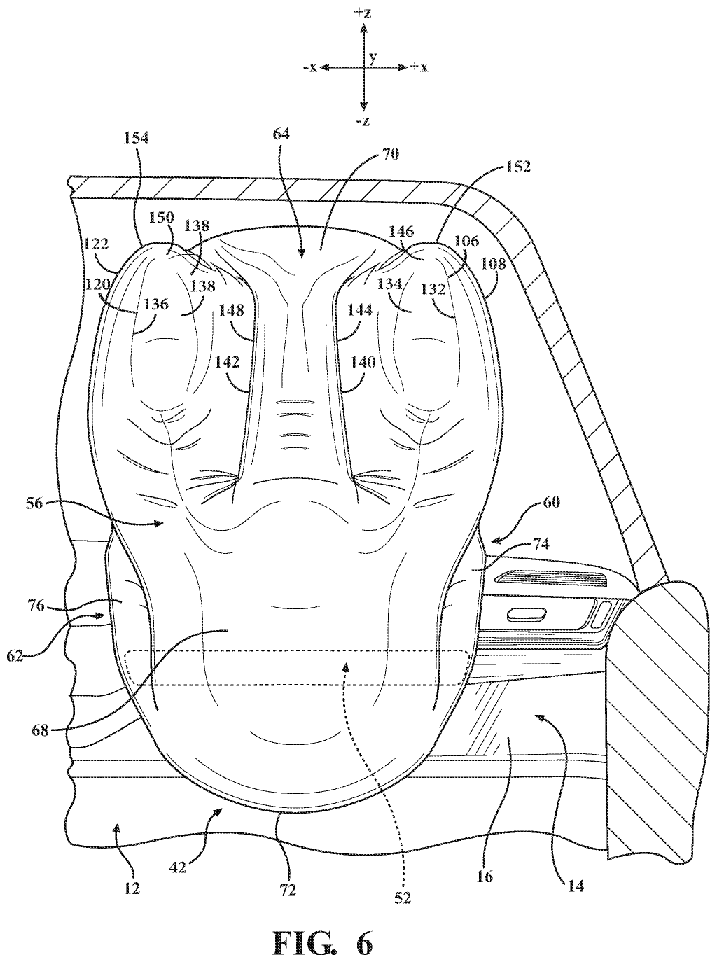

More particularly, the perimeter panel 64 or the first side panel 60 is positioned such that the first lobe edge 106 on the first side panel 60 mates with the third lobe edge 132 on the perimeter panel 64. The first lobe edge 106 and the third lobe edge 132 are then sewn together. The first lobe bulge 108 and the third lobe bulge 134 extend outward from a first recess 144 at the airbag 42 at to form a first bulge 146, as shown in FIG. 6.

Similarly, the perimeter panel 64 or the second side panel 62 is positioned such that the second lobe edge 120 on the second side panel 62 mates with the fourth lobe edge 136 on the perimeter panel 64. The second lobe edge 120 and the fourth lobe edge 136 are then sewn together. The second lobe bulge 122 and the fourth lobe bulge 138 extend outward from a second recess 148 of the airbag 42 to form a second bulge 150, as shown in FIG. 6.

Furthermore, it is to be appreciated that joining the first and second side panels 60, 62 to the perimeter panel 64 forms the nose section 78 between the first and second nose bulges 100, 114 and the tail bag body 58 between the first and second tail bulges 104, 118. It should be appreciated that the height and the depth of each of the nose section 78 and the tail bag body 58 are defined by the extent which the first and second nose bulges 100, 114 and the first and second tail bulges 104, 118 extend from their respective side panels 60, 62. For instance, the height Ht and depth Dt of the tail bag body 58 may be increased in order to provide a more snug fit within the cavity 24 of the instrument panel 14 by increasing the amount of which the first and second tail bulges 104, 118 extend away from each side panel 60, 62.

Additionally, it should be appreciated that, when the cavity 24 of the instrument panel 14 has a height Hc or a depth Dc that differs from one end of the cavity 24 to the other, then the size of the first and second tail bulges 104, 118 may differ from one another in order to provide a uniform fit between the tail bag body 58 and the cavity 24 throughout the entire cavity 24. Thus, in some embodiments when the size of the cavity 24 tapers toward the side wall 32, the second tail bulge 118 on the second side panel 62, which is provided on the tapered side of the cavity 24, is smaller than the first tail bulge 104 on the first side panel 60.

While the above description of assembling the side panels 60, 62 with the perimeter panel 64 describes sewing the panels 60, 62, 64 to one another, it should be understood that the panels 60, 62, 64 may also be attached in any other suitable manner, such as using a fusible adhesive, tape, or webbing, using fabric glue, fabric welding, or the like.

As shown in FIG. 6, a rear view of the airbag 42 in its assembled state is shown. The first and second lobes 152, 154 are formed on the rear section 68 of the airbag 42. As noted above, the first lobe 152 is formed by the first and third lobe bulges 108, 134 being sewn together at the first and third lobe edges 106, 132 and further defined by the first recess 144 formed by the first interior sew line 140. Similarly, the second lobe 154 is formed by the second and fourth lobe bulges 122, 138 being sewn together at the second and fourth lobe edges 120, 136 and further defined by the second recess 148 formed by the second interior sew line 142. As shown, the first and second interior sew lines 140, 142 prevent the airbag 42 from fully inflated when in the deployed state.

The first and second lobes 152, 154 formed on opposite sides of the airbag 42 provide additional support to the occupant by covering opposite sides of the occupant's head. This can prevent movement of the occupant in the vehicle lateral direction upon impact and also prevent incoming debris from the vehicle during a collision from striking the occupant's head.

In order to facilitate a better understanding of the present disclosure, operation of the airbag 42 during a collision will be described.

As noted above, in some embodiments, the inflator 54 is electrically connected to the collision sensor positioned in a forward location of the vehicle 10 to determine when an impact effecting the front of the vehicle 10 occurs. In other embodiments, the inflator 54 is electrically connected to the ECU or the airbag ECU, which is electrically connected to the collision sensor. When the collision sensor identifies a collision exceeding a specified threshold, the inflator 54 ejects gas into the airbag 42, specifically, the main bag body 56 through the nose section 78 of the airbag 42. This causes the airbag 42 to inflate and apply a force against the rupturable door 40 in the instrument panel 14. The three rupturable edges 44, 46, 48 of the rupturable door 40 then separate from the instrument panel 14 in order to allow the rupturable door 40 to open into the passenger compartment 12 of the vehicle 10 and allow the airbag 42 to inflate.

As shown in FIG. 2, the airbag 42 partially expands toward the rear of the instrument panel 14 as the main bag body 56 inflates with gas. However, the nose section 78 of the airbag 42 remains attached to the airbag housing 52 to generally maintain its orientation within the passenger compartment 12 relative to the instrument panel 14. Once the airbag 42 is positioned rearward of the instrument panel 14 and during inflation of the main bag body 56, the tail bag body 58, which is uninflated, is positioned within the cavity 24 of the instrument panel 14. The main bag body 56 inflates to a threshold internal pressure and the vent hole 80 on the first side panel 60 of the airbag 42 permits gas to escape in order to prevent an excessive amount of pressure from building within the main bag body 56 and causing the airbag 42 to rupture. Prior to gas being released through the vent hole 80, gas flows through the main bag body 56 and into the tail bag body 58 located within the cavity 24 of the instrument panel 14.

The tail bag body 58 fills with gas to inflate within the cavity 24 of the instrument panel 14. Once the tail bag body 58 fully inflates, the tail bag body 58 fills the cavity 24 between the upper wall 26, the lower wall 30, and the front wall 28 of the cavity 24. As noted above, in some embodiments, the height Ht and the depth Dt of the tail bag body 58 is such that at least one of the upper surface 84 and the lower surface 86 of the tail bag body 58 contacts at least one of the upper wall 26 and the lower wall 30 of the cavity 24. In other embodiments, the first and second tail bulges 104, 118 are dimensioned, as discussed herein, to provide an increased height Ht and the depth Dt of the tail bag body 58, thereby providing a more snug fit within the cavity 24 of the instrument panel 14.

Upon impact of a front passenger contacting the main bag body 56, momentum of the front passenger forces the main bag body 56 in the vertical direction. However, it should be appreciated that the tail bag body 58 extending into the cavity 24 restricts movement of the airbag 42 in the vehicle vertical direction. Specifically, when momentum of the front passenger forces the main bag body 56 in the upward in the vehicle vertical direction, the upper surface 84 of the tail bag body 58 contacts the upper wall 26 of the cavity 24 and prevents upward movement the airbag 42. Similarly, when momentum of the front passenger forces the main bag body 56 downward in the vehicle vertical direction, the lower surface 86 of the tail bag body 58 contacts the lower wall 30 of the cavity 24 and prevents downward movement the airbag 42.

Vertical movement of the airbag 42 may be prevented as discussed above even when the height Ht of the tail bag body 58 is less than the height Hc of the cavity 24. However, when the height Ht of the tail bag body 58 is equal to the height Hc of the cavity 24 such that the upper surface 84 and the lower surface 86 of the tail bag body 58 contact both the upper wall 26 and the lower wall 30 of the cavity 24, vertical movement of the airbag 42 in both upward and downward directions can be prevented.

In addition, it should be appreciated that the tail bag body 58 also prevents movement of the airbag 42 in the vehicle lateral direction. Specifically, when momentum of the front passenger forces the main bag body 56 toward the driver side of the vehicle 10, the side surface 92 of the tail bag body 58 contacts the side wall 32 of the cavity 24 in the instrument panel 14 and prevents movement of the airbag 42 toward the driver side of the vehicle 10. Similarly, when momentum of the front passenger forces the main bag body 56 away from the driver side of the vehicle 10, the opposite side surface 90 of the tail bag body 58 contacts the opposite side wall of the cavity 24 in the instrument panel 14, if provided, and prevents movement the airbag 42 away from the driver side of the vehicle 10. If the cavity 24 of the instrument panel 14 does not include an opposite side wall, the front passenger door may function as a suitable side wall in order to prevent lateral movement of the airbag 42 away from the driver side of the vehicle 10.

Lateral movement of the airbag 42 may be prevented as discussed above even when the width Wt of the tail bag body 58 is less than the width Wc of the cavity 24. However, when the width Wt of the tail bag body 58 is equal to the width Wc of the cavity 24, such that the side surfaces 90, 92 of the tail bag body 58 contact both the side wall 32 of the cavity 24 and the opposite side wall or front passenger door, lateral movement of the airbag 42 in both directions can be prevented.

When the depth Dt of the tail bag body 58 is such that the front surface 88 thereof does not contact the front wall 28 of the cavity 24 of the instrument panel 14, forward moment of a front passenger causes the lower section 82 of the main bag body 56 proximate the tail bag body 58 to move forward in the vehicle longitudinal direction. Thus, in some embodiments, the depth Dt of the tail bag body 58 is such that that the front surface 88 of the tail bag body 58 extends into the cavity 24 of the instrument panel 14 and contacts the front wall 28 thereof in order to limit movement of the airbag 42 in the vehicle longitudinal direction.

From the above, it is to be appreciated that defined herein is a new and unique airbag for a vehicle that prevent movement of the airbag in at least a vehicle vertical direction upon impact with an occupant.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An airbag for a vehicle including an instrument panel having a cavity defined by an upper wall, a front wall, and a lower wall, the airbag comprising:
a main bag body; and
a tail bag body, the tail bag body extending forward from the main bag body in a vehicle longitudinal direction and the tail bag body extending into the cavity when the airbag is in a deployed state.

2. The airbag of claim 1, wherein the tail bag body inhibits movement of the main bag body in a vehicle vertical direction when the airbag is in the deployed state.

3. The airbag of claim 1, wherein the tail bag body contacts at least one of the upper wall, the front wall, and the lower wall of the cavity.

4. The airbag of claim 3, wherein the tail bag body has an upper surface contacting the upper wall of the cavity, a front surface contacting the front wall of the cavity, and a lower surface contacting the lower wall of the cavity.

5. The airbag of claim 1, further comprising:
an inflator for inflating the main bag body with a gas, the gas flowing from the main bag body to the tail bag body to inflate the tail bag body.

6. The airbag of claim 1, wherein the instrument panel has at least one side wall defining at least one side of the cavity, the tail bag body contacting the at least one side wall of the instrument panel to inhibit movement of the main bag body in a vehicle lateral direction when the airbag is in the deployed state.

7. The airbag of claim 1, wherein the tail bag body has a width defined by a first side surface and a second side surface, the main bag body has a width defined by a first side panel and a second side panel, wherein the width of the tail bag body is equal to the width of the main bag body.

8. A vehicle instrument panel assembly comprising:
an instrument panel including an upper wall, a front wall, and a lower wall defining a cavity, the instrument panel including an airbag housing; and
an airbag operable between an undeployed state and a deployed state, the airbag housed within the airbag housing when in the undeployed state, the airbag including a main bag body and a tail bag body, the tail bag body extending forward from the main bag body in a vehicle longitudinal direction and the tail bag body extending into the cavity when the airbag is in the deployed state.

9. The vehicle instrument panel assembly of claim 8, wherein the tail bag body inhibits movement of the main bag body in a vehicle vertical direction when the airbag is in the deployed state.

10. The vehicle instrument panel assembly of claim 8, wherein the tail bag body contacts at least one of the upper wall, the front wall, and the lower wall of the cavity.

11. The vehicle instrument panel assembly of claim 10, wherein the tail bag body has an upper surface contacting the upper wall of the cavity, a front surface contacting the front wall of the cavity, and a lower surface contacting the lower wall of the cavity.

12. The vehicle instrument panel assembly of claim 8, further comprising:
an inflator for inflating the main bag body with a gas, the gas flowing from the main bag body to the tail bag body to inflate the tail bag body.

13. The vehicle instrument panel assembly of claim 8, wherein the instrument panel has at least one side wall defining at least one side of the cavity, the tail bag body contacting the at least one side wall of the instrument panel to inhibit movement of the main bag body in a vehicle lateral direction when the airbag is in the deployed state.

14. The vehicle instrument panel assembly of claim 8, wherein the tail bag body has a width defined by a first side surface and a second side surface, the main bag body has a width defined by a first side panel and a second side panel, wherein the width of the tail bag body is equal to the width of the main bag body.

15. A vehicle comprising:
a passenger compartment; and
a vehicle instrument panel assembly provided in the passenger compartment, the vehicle instrument panel assembly comprising:
an instrument panel including an upper wall, a front wall, and a lower wall defining a cavity, the instrument panel including an airbag housing; and
an airbag operable between an undeployed state and a deployed state, the airbag housed within the airbag housing when in the undeployed state, the airbag including a main bag body and a tail bag body, the tail bag body extending forward from the main bag body in a vehicle longitudinal direction and the tail bag body extending into the cavity when the airbag is in the deployed state.

16. The vehicle of claim 15, wherein the tail bag body inhibits movement of the main bag body in a vehicle vertical direction when the airbag is in the deployed state.

17. The vehicle of claim 15, wherein the tail bag body contacts at least one of the upper wall, the front wall, and the lower wall of the cavity.

18. The vehicle of claim 17, wherein the tail bag body has an upper surface contacting the upper wall of the cavity, a front surface contacting the front wall of the cavity, and a lower surface contacting the lower wall of the cavity.

19. The vehicle of claim 15, further comprising:
an inflator for inflating the main bag body with a gas, the gas flowing from the main bag body to the tail bag body to inflate the tail bag body.

20. The vehicle of claim 15, wherein the instrument panel has at least one side wall defining at least one side of the cavity, the tail bag body contacting the at least one side wall of the instrument panel to inhibit movement of the main bag body in a vehicle lateral direction when the airbag is in the deployed state.
